(19) United States
(12) Patent Application Publication
(10) Pub. No.: US 2005/0229477 A1
(43) Pub. Date: Oct. 20, 2005

(54) Crustacean trap

(76) Inventor: Eduardo R. Gomez JR., Southwest Ranches, FL (US)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 11/109,505

(22) Filed: Apr. 19, 2005

Related U.S. Application Data
(60) Provisional application No. 60/563,875, filed on Apr. 20, 2004.

(51) Int. Cl. A01K 69/06

(52) U.S. Cl. 43/100

(57) ABSTRACT

The present invention provides a crustacean trap having a top cover and a plurality of substantially planar side panels extending downward from the cover. The top cover and the side panels define an interior space therebetween. At least one side panel may include an aperture adapted to receive a degradable element such that the degradable element substantially obstructs the aperture. The crustacean trap may also include at least one side panel having a one-way pivotable gate opening away from the interior space, with the gate having one or more protrusions spaced apart by a predetermined width.

### CROSS-REFERENCE TO RELATED APPLICATION

This application is related to and claims priority to U.S. Provisional Patent Application Ser. No. 60/563,875, filed Apr. 20, 2004, entitled CRUSTACEAN TRAP, the entirety of which is incorporated herein by reference.

### STATEMENT REGARDING FEDERALLY SPONSORED RESEARCH OR DEVELOPMENT

n/a

The present invention relates to sea-animal traps and more specifically to a sturdy crustacean trap that includes apertures to allow crustaceans to enter the trap and one or more strategically located escape hatches positioned in such a manner that crustaceans that remain in the trap for an extended period of time have a means of egress.

### BACKGROUND OF THE INVENTION

Traps used at sea to trap crustaceans such as crabs, lobsters and the like are well known in the art. Common wire traps are often submerged in the ocean and crustaceans enter the trap via an aperture that is large enough to allow entrance into the inner area of the trap. Once the crustacean enters the trap through the aperture it has difficulty escaping since the location of the aperture, typically in the top frame of the trap, prohibits egress. This is because the arrangement of the trap prohibits the crustacean from climbing the interior walls of the trap and out of the aperture through which it entered. Further, wire traps are often flimsy and get snagged on sea plants thereby preventing easy extraction of the trap, and creating potential environmental hazards.

While it is the purpose of crustacean traps to trap sea-animals, environmental regulations have strict requirements regarding the size and type of crustacean that can be trapped and the length of time a crustacean can be confined in a trap. Sea-animals that have been caught in a trap must be extracted after a certain period of time. If not, they must be given the chance to escape. Therefore, traps must include an escape hatch to provide the sea-animals that are still alive after a certain length of time with a means of egress. However, the escape hatch in these traps is typically positioned too high for the crustacean to escape. As noted above, crustaceans generally cannot climb the walls of a trap and force their way out of an escape hatch positioned on the upper portion of the wall of the trap. Further, most traps inadvertently trap small or baby crustaceans. These young crustaceans are not meant to be trapped since environmental regulations prohibit the trapping of baby crustaceans. These young crustaceans cannot climb their way out of the trap through the escape hatch and are too large to exit through the narrow slits that are in the trap's side walls.

While there exists plastic, crate-like crustacean traps, many are poorly designed and lack easy opening covers. These traps fail to provide conveniently located escape hatches and do not provide egress for small crustaceans. Further, many traps that are stacked while in storage are damaged due to the lack of any protective device that serves to protect the frame of the trap from the weight of other stacked traps.

It is therefore desirable to provide a crustacean trap apparatus that can be submerged in water to capture sea-animals and that provides convenient escape means for sea-animals that are trapped for an extended amount of time in order to comply with environmental regulations. It is also desirable to provide an apparatus that is sturdy, and that can withstand the weight of other traps that may be stacked upon it during storage.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, wherein like designations refer to like elements, and wherein:

FIG. 1 is a perspective view of the crustacean trap of the present invention;

FIG. 2 is a perspective view of adjacent side walls of the crustacean trap illustrating the interlocking tabs and channel;

FIG. 3 is a perspective view of the crustacean trap illustrating the interlocking mechanism between adjacent walls;

FIG. 4 is a left, side view of the crustacean trap of the present invention with the top cover swung open;

FIG. 5 is a right, side view of the crustacean trap of the present invention; and

FIG. 6 is a top view of the crustacean trap of the present invention.

### DETAILED DESCRIPTION OF THE INVENTION

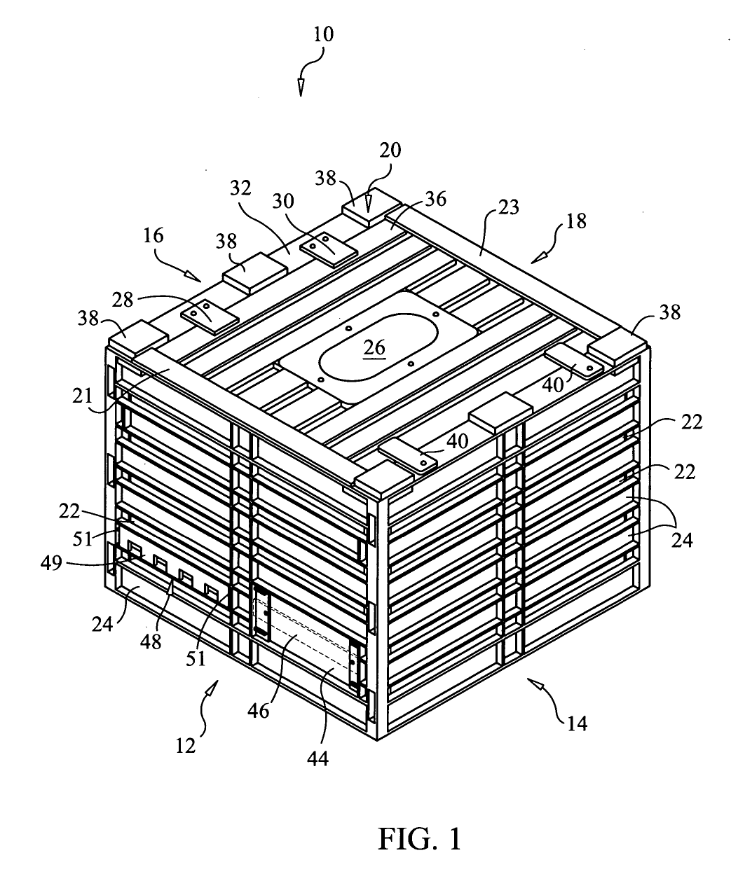

Referring now to the drawing figures in which like reference designators refer to like elements, there is shown in FIG. 1 a crustacean trap constructed in accordance with the principles of the present invention and designated generally as 10. As shown in FIG. 1, trap 10 is a generally cube-like structure having four adjacent side, i.e. front side 14, left side 12, right side 18 and rear side 16, and a top cover 20, all of which enclose a defined interior space. Typically, the bottom of trap 10 is open but is adapted to include a slab of cement, which can be formed in place to comprise the floor of the trap. The cement provides weight to the trap allowing it to sink below the water surface.

The crustacean trap 10 of the present invention is formed by four molded polymer sides (12, 14, 16 and 18) and a hinged top cover 20. Once the four sides are assembled, the bottom of trap 10 is formed by placing the assembled sides on a surface and filling the bottom of the trap with a substance that can be poured to set as a solid mass such as a resin, concrete or the like. The formed bottom is held in place by protrusions on the lower inner portions of the sides.

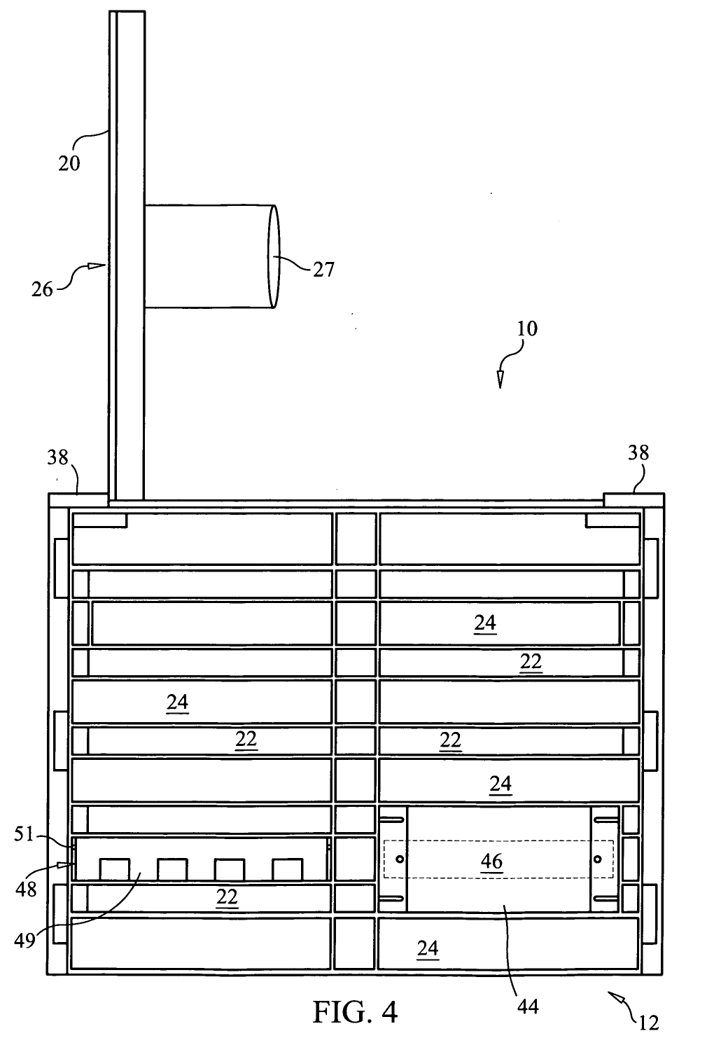

Top cover 20 is hingedly coupled to rear side 16 by two hinges 28 and 30 such that each hinge is screwed to the top of rear side 16. Cover 20 includes two cylindrical molded elements which axially rotate within each hinge (as shown in FIG. 4). Cover 20 includes planar areas 21 and 23 on its left and right sides, respectively, which allow cover 20 to rest against the left side 12 and the right side 18 of trap 10 to prevent cover 20 from rotating into the inner volume of trap 10 formed by the sides of the trap.

The mechanism for keeping cover 20 closed is two pivotable latches 40 mounted to the top of front side 14 of trap 10. Each of the two latches 40 pivots about a screw fixing the latch to front side 14. To lock cover 20, latches 40 are rotated so that they extend over the top of cover 20, preventing the cover from opening.

Entrance and egress to and from the inner volume of trap 10 when cover 20 is in a closed position is formed by an ellipse-like opening 26 in cover 20 having a wall 27 orthogonal to the plane of cover 20 extending part way into the trap's inner volume thereby providing a uniform cross-section (seen in FIG. 4). The cross-section area of the aperture at cover 20 is the same as the cross-section area at the opposite end of the wall inside trap 10.

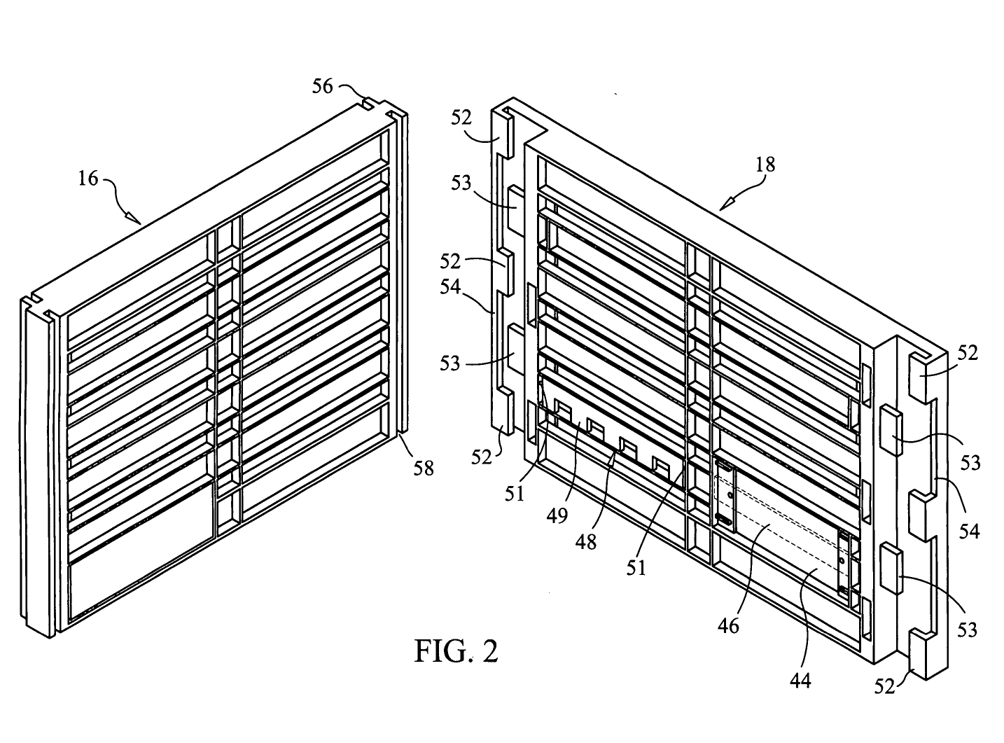

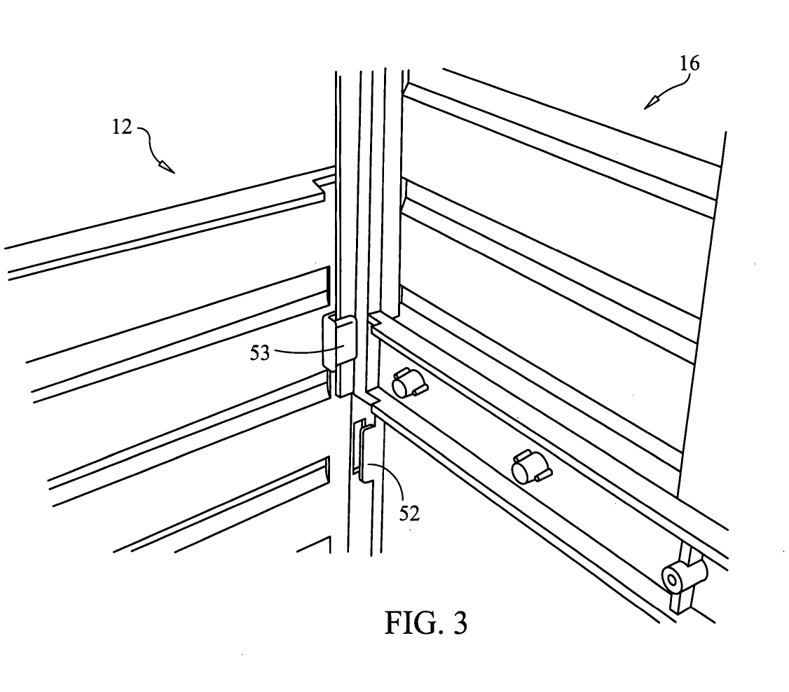

Referring now to FIGS. 2 and 3, it can be seen that trap 10 is formed by slidably engaging adjacent walls, for example, right side 12 with rear side 16, and left side 12 with rear side 16. The side edges of the left and right sides include a set of tabs 52 facing toward the center of the sides and a set of opposite facing tabs 53, i.e. tabs that face the outer edge of the sides. Substantially horizontal apertures 22 (as shown in FIG. 1) in the sides make the tabs visible from the outside when the sides are not coupled together and allow for visual inspection of the adjacent side during the process of coupling together adjacent sides. The edges of the left and right sides 12 and 18 are molded such that the inward facing tabs 52 are positioned over a rectangular channel 54 formed in the edge. The outward facing tabs 53 are positioned over the planar portion of the sides extending to the peripheral edge of channel 54.

The front and rear sides 14 and 18 include lengthwise edge margins 56, which interlock with channel 54 and tabs 52 and 53 formed in the left and right sides 12 and 18. An inward-facing margin 58 faces toward the inner volume of trap 10 and slidably engages the outward-facing pair of tabs 53 on the adjacent side panel. The outer edge of the front and rear side panels forms a margin 56 which faces outside of the trap and slidably engages into channel 54 formed in the adjacent left or right side panel, being held in place by the three inward-facing tabs 52. The engagement of left side 12 and rear side 16 can be seen in FIG. 3.

Of note, the depth of the channel 54 formed in the side panel is less than the thickness of margin 58 formed on the front and rear panel so that when engaged, margin 58 is held in place in channel 54 by the inward facing tabs 52 as well as by the engagement of the outward facing tabs 53 and their pressure on the inward facing margin 58.

Referring again to FIG. 1, trap 10 is preferably constructed of rigid plastic and includes a series of substantially horizontal apertures 22 disposed within each wall as well as the top cover 20. Between apertures 22 are a series of substantially horizontal panels 24. The distance between panels 24 is sufficiently small such that crustaceans that enter the trap 10 cannot easily escape. Crustaceans typically enter trap 10 via an entrance orifice 26 located in the substantial center of top cover 20. Entrance orifice 26 is preferably oval in shape and is sized to allow crustaceans to enter the trap. Because orifice 26 is located in top cover 20 and in the substantial center, away from walls 12, 14, 16 and 18, it is difficult for a crustacean, once it has entered trap 10, to climb up any of the interior of the walls and escape through entrance orifice 26.

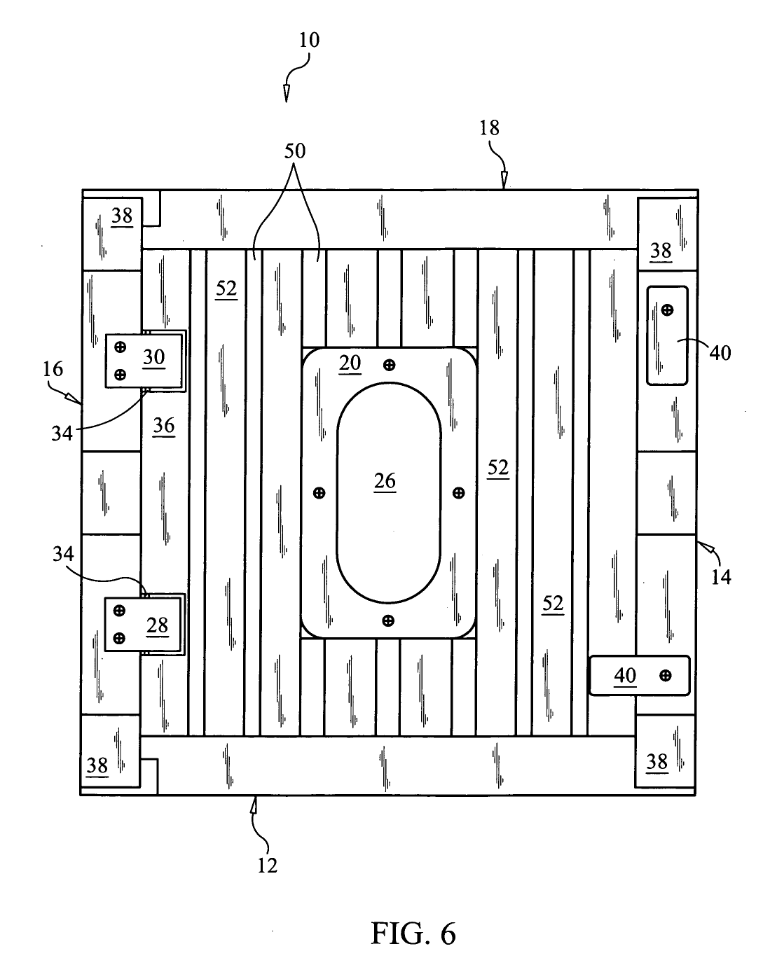

Top cover 20 is rotatably connected to side wall 16 via hinges 28 and 30. Hinges 28 and 30 are affixed at one end to panel 32 via screws or other similar affixing device. The portion of hinges 28 and 30 that are not affixed to panel 32 form a loop and enclose a rod 34 extending underneath panel 36 (shown in FIG. 6). Rod 34 can freely rotate within the loop portion of hinges 28 and 30 thereby allowing top cover 20 to swing open and any sea-animals that are contained within trap 10 to be easily removed.

Trap 10 also includes four support blocks 38 located at each top corner of trap 10 and two additional support blocks 38 located at the substantial midpoint between two corner blocks as shown in FIG. 1. Blocks 38 may be affixed to the top of trap 10 or be formed as an integral part of the trap. Each block 38 projects upward from the corner of trap 10 and provides a “cushion” that prevents damage to cover 20 if multiple traps 10 are stacked on top of each other during storage. Each raised block 38 receives the direct weight of an upper, stacked trap and prevents damage by maintaining a space between the lower corners of the uppermost trap and the cover or top corners of the walls of the lower trap. Using the crustacean trap of the present invention, multiple traps can be stacked on top of each other during storage without any damage to the framework of the traps themselves.

FIG. 1 also illustrates a pair of securing latches 40. Latches 40 are secured to an upper panel surrounding top cover 20 via a screw or similar attachment device. Latches 40 rotate about the attachment device and may be rotated to cover a portion of top cover 20 when it is desired to secure the top cover 20 and prevent it from swinging open. To open top cover 20, latches 40 are rotated to a substantially horizontal position with respect to a top panel 42 of trap 10 and cover 20 is swung open. The interior walls of orifice 26 may be used as a handle that the user can grasp to swing open cover 20. Lateral ridges along the underside of top cover 20 allow it to rest on front wall 12 and side walls 14 and 16 to prevent cover 20 from swinging into the defined inner volume of trap 10.

In FIG. 1, escape hatch 44 can be seen. Escape hatch 44 is an aperture situated near the bottom of side 12 of trap 10. Alternately, escape hatch can be situated on any other side (14, 16 or 18) of trap 10. Environmental regulations require that all submerged sea traps include an escape hatch to allow captured sea-animals that have not been extracted from the trap a means of escape. Apertures 22 are too narrow to allow captured sea-animals to escape. The trap of the present invention includes an escape hatch 44 lower than other traps to provide sea animals that have not been extracted from the trap a means of egress. Other prior art traps include an escape hatch high on one side of the trap, making it extremely difficult if not impossible for a crab or other sea animal to climb up the interior side walls of the trap and attempt to escape through the escape hatch.

Escape hatch divider 46 is positioned at the substantial midpoint of escape hatch 44 and secured to the side of the escape hatch 44 via an attachment device such as one or more screws. Divider 46 is preferably a sliver of biodegradable material such as wood, which, after extended exposure to water, will become soft and degrade. Divider 46 bisects the opening in the escape hatch, making it more difficult for average-sized sea animals to escape. However, after trap 10 has been submerged in water for several days, the wood degrades, making it relatively easy for the captured sea-animal to chew through the wood and escape. Divider 46 serves to prevent immediate escape of the sea-animals, which is the desired effect, yet sufficiently degrades after extended submersion in order to give the trapped sea-animals a means of escape. The location of escape hatch 44, i.e., proximate the trap floor, eliminates the need for the captured sea-animal to climb the interior walls of the trap first, and then chew or claw its way out of the escape hatch.

Trap 10 typically includes as its floor, a slab of cement (not shown) secured to the interior walls and cast in place. The slab rests on four or more protrusions or other similar supporting members that project inward from the interior walls of trap 10. The slab of concrete serves as a floor for the trap and further provides the necessary weight to allow trap 10 to sink below the surface of the water to a location where sea-animals may congregate.

Hinges 28 and 30 described above allow top cover 20 of trap 10 to be swung open, resulting in the configuration shown in FIG. 4. FIG. 4 is a left, side view of the crustacean trap 10 of the present invention. In FIG. 4, top cover 20 is in the open position. An open-ended cylinder 27 extends from underneath cover 20. Cylinder 27 is open and both ends to allow sea-animals to enter trap 10 via orifice 26 (the cylinder's upper end) when cover 20 is in the closed position. Escape hatch 44 can be seen in the lower right-hand corner of front side 12 of trap 10. Escape hatch divider 46 bisects escape hatch 44 and initially prevents egress of trapped sea-animal. After several days of submersion, sea-animals that have not been removed from the trap may eat or claw their way through divider 46 and escape via hatch 44.

When swung open, cover 20 pivots about hinges 28 and 30 (not shown in FIG. 4) and remains in a substantially vertical position as shown in FIG. 4. Panels 24 and apertures 22 therebetween can be seen on front face 12. Raised blocks 38 are shown to project slightly above the horizontal plane of the trap's frame in order to prevent damage from stacked traps.

FIGS. 1 and 2 also shows swing gate 48. In FIG. 1, gate 48 is located adjacent escape hatch 44 on side 12 but may just as easily be located on any side of trap 10. For example, in FIG. 2, gate 48 is located, along with hatch 44, on side 18 of trap 10. Further, more than one hatch 44 and gate 48 may be included in trap 10. Gate 48 is pivotally connected to one of the lower panels 24. Gate 48 acts as a one-way flap that allows trapped sea-animals to exit the trap. Gate 48 includes one or more fingers 49 that are of a specified width that prevents small crustaceans from exiting through the gate. Only when gate 48 is pushed outward can the crustaceans escape. Gate 48 is configured in such a way that it cannot open when pressure is applied from outside trap 10 thereby preventing sea-animals from entering the trap through gate 48. However, when pressure is applied to the gate from within the trap, the gate 48 swings outward. Gate 48 is adapted to provide smaller crustaceans that are inadvertently trapped with a means of egress. In an alternate embodiment, gate 48 is replaced by a groove cut into lower panel 24. This increases the area between panel 24 and an adjacent aperture 22 thus allowing smaller sea-animals to escape from within trap 10.

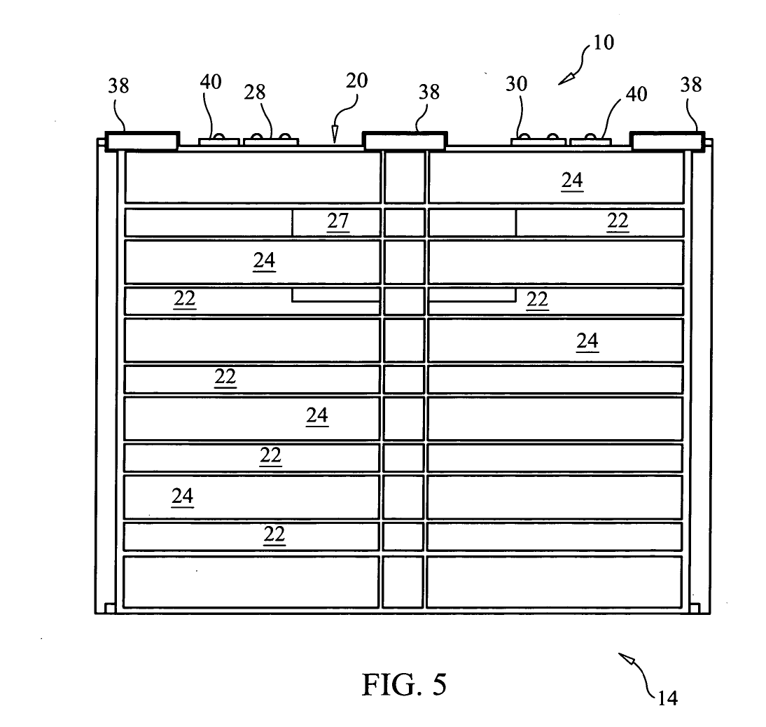

FIG. 5 illustrates a side view of the crustacean trap 10 of the present invention. In this configuration, side 14 is shown without an escape hatch or a gate. Hatch 44 may be included in one or more of the side walls 12, 14, 16 or 18. Similarly, gate 48 may be included in one or more of the side walls.

Because environmental regulations prohibit the trapping of young or undersized crustaceans, gate 48 provides a way for inadvertently trapped crustaceans to easily make their way out of the trap interior. When the gate 48 is pushed open from within the trap, a space between panel 24 and aperture 22 is created that is larger than the space between other panels and apertures of the trap. This added space near the lower end of trap 10 allows young sea-animals to escape without the need to climb up the interior walls of the trap. The placement of gate 48 may vary. For example, gate 48 may be placed on any side of trap 10 and may be affixed to any panel 24. However, the placement of gate 48 is preferably near the bottom of trap 10 to eliminate the need for small sea-animals to have to climb the interior of the trap in order to escape.

FIG. 6 illustrates a top view the trap 10 of the present invention. Orifice 26 is positioned in the substantial center of cover 20. Hinges 28 and 30 are pivotally connected to cover 20 allowing the cover to be freely swung open and the contents of the trap to be removed. For illustrative purposes, latches 40 are shown in two different positions. The upper latch is in a position that allows cover 20 to be opened. Both latches must be in this position to open cover 20. The lower latch is in a “locked” position and covers cover 20 to prevent unwanted opening. Grooves 50 are disposed along top cover 20 to allow water seepage.

The crustacean trap 10 of the present invention is a light-weight yet sturdy trap that traps crustaceans while providing easy escape for crustaceans remaining in the trap after an extended period of time via one or more escape hatches and/or an outward-opening gate. The escape hatches are located proximate the bottom of the trap. This provides an easy escape route for trapped crustaceans that have not been removed from the trap. A degradable divider, preferably a thin piece of wood, is secured to each side of the escape hatch walls and prevents immediate escape. After a period of time, perhaps several days of submersion, the wood degrades and may be eaten or clawed through to allow the crustaceans to escape. This is in accord with environmental requirements that prohibit sea-animals to be trapped for an extended period of time without being removed.

Further, the present invention provides an outward-opening gate 48 allows smaller, inadvertently trapped crustaceans an easy way to escape the trap. Support blocks 38 disposed along the upper edges of the trap protect the trap frame by supporting the weight of stacked traps. Latches 40 provide a quick and easy means to open or secure the trap cover 20. A cement slab serves as the bottom floor of the trap and is preferably supported by a series of nails or inwardly protruding members extending from the interior walls of the trap.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A crustacean trap, comprising:
a plurality of substantially planar side panels; and
a top cover pivotally coupled to one of the plurality of side panels, the top cover and the side panels defining an interior space therebetween, wherein at least one side panel includes a pivoting gate.

2. The crustacean trap of claim 1, wherein at least one side panel includes an aperture adapted to receive a degradable element such that the degradable element substantially obstructs the aperture.

3. The crustacean trap of claim 2, further comprising a base affixed to the plurality of side panels opposite the top cover.

4. The crustacean trap of claim 3, wherein the aperture in the side panel is proximate the base.

5. The crustacean trap of claim 1, wherein the pivoting gate is a one-way gate opening away from the interior space.

6. The crustacean trap of claim 1, wherein the pivoting gate includes one or more protrusions spaced apart by a predetermined width.

7. The crustacean trap of claim 1, wherein the top cover defines an opening providing access to the interior space.

8. The crustacean trap of claim 1, further comprising one or more blocks disposed upon a top surface of at least one side panel, the one or more blocks preventing damage to the trap during stacking of said traps.

9. The crustacean trap of claim 1, wherein at least one side panel includes a rotatable latch positionable such that a portion of the latch extends over a portion of the top cover, thereby preventing the top cover from opening.

10. A crustacean trap, comprising:
a top cover; and
a plurality of substantially planar side panels extending downward from the cover, the top cover and the side panels defining an interior space therebetween, wherein at least one side panel includes an aperture adapted to receive a degradable element such that the degradable element substantially obstructs the aperture, and wherein at least one side panel includes a one-way pivotable gate opening away from the interior space.

11. A crustacean trap, comprising:
opposing substantially planar end walls, each end wall including an edge margin disposed along each end of each end wall;
opposing substantially planar side walls, each side wall including a plurality of tabs disposed along each end of each side wall, wherein the plurality of tabs on each end of each side wall are slidably received by an edge margin of an adjacent end wall; and
a top cover pivotally affixed to one of the end walls, such that the top cover, the opposing end walls, and the opposing side walls define an interior space.

12. The crustacean trap of claim 11, wherein one of the end walls and the side walls include a pivoting gate.

13. The crustacean trap of claim 12, wherein one of the end walls and the side walls includes an aperture adapted to receive a degradable element such that the degradable element substantially obstructs the aperture.

14. The crustacean trap of claim 13, further comprising a base affixed to the opposing end walls and opposing side walls, opposite the top cover.

15. The crustacean trap of claim 13, wherein the aperture is proximate the base.

16. The crustacean trap of claim 12, wherein the pivoting gate is a one-way gate opening away from the interior space.

17. The crustacean trap of claim 12, wherein the pivoting gate includes one or more protrusions spaced apart by a predetermined width.

18. The crustacean trap of claim 11, wherein the top cover includes an opening providing access to the interior space.

19. The crustacean trap of claim 11, further comprising one or more blocks disposed upon a top surface of one of the end walls and side walls, the one or more blocks to prevent damage to the trap during stacking of said traps.
